(19) United States
(12) Patent Application Publication
(10) Pub. No.: US 2023/0030902 A1
(43) Pub. Date: Feb. 2, 2023

(54) MODULAR HORTICULTURE PLATFORM

(71) Applicant: VERTICAL FIELD LTD., Raanana (IL)

(72) Inventor: Guy BARNESS, Hod Hasharon (IL)

(21) Appl. No.: 17/789,575

(22) PCT Filed: Jan. 4, 2021
(86) PCT No.: PCT/IL2021/050009

§ 371 Date: Jun. 28, 2022

(30) Foreign Application Priority Data
Jan. 5, 2020 (IL) 271841

(51) Int. Cl. A01G 9/02; A01G 27/00

(52) U.S. Cl. CPC A01G 9/025; A01G 27/005

(57) ABSTRACT

A vegetable growth module comprises: a) a rack divided into two or more compartments located vertically one above each other, each compartment being adapted to house a growth tray base; b) an upper segment adapted to house a water-deflecting tub; c) elements adapted to fasten the rack to a vertical wall; and d) water flow and flow-direction elements provided within the rack, to direct the flow of water from one compartment to another compartment located below it.

### FIELD OF THE INVENTION

The present invention relates to the field of horticulture. More particularly, the invention relates to a vertical, modular horticulture platform (also referred to herein as “module” for brevity), suitable for a variety of vegetable growths.

### BACKGROUND OF THE INVENTION

Growing vegetables vertically has become important particularly in urban environments in which land is scarce and walls are plentiful. However, growing vegetables, and particularly edible ones, presents many challenges. For instance, different vegetables have different water and fertilizer requirements, which makes growing different vegetables in the same place difficult. Moreover, vegetables that are grown must reach the market at the appropriate time and in a convenient form for customers to purchase them while they are wholesome. Timing the growth and the supply in a way that provides for fresh vegetables while avoiding wastes, requires sophistication that the art so far has failed to provide. Therefore, it would be highly desirable to provide vegetable growing systems that overcome the aforesaid drawbacks of the prior art.

It is an object of the present invention to provide a modular vegetable growing system that can be applied to a great variety of vegetable growths, both edible and non-edible.

It is another object of the invention to provide a system that overcomes the disadvantages of the prior art and allows growing different vegetable growths in the same location.

It is a further object of the invention to provide a system that allows for a convenient way to make vegetables grown available for purchase to the general public.

Other objects and advantages of the invention will become apparent as the description proceeds.

### SUMMARY OF THE INVENTION

The invention relates to a# vegetable growth module comprising:
a) a rack divided into two or more compartments located vertically one above each other, each compartment being adapted to house a growth tray base;
b) an upper segment adapted to house a water-deflecting tub;
c) elements adapted to fasten the rack to a vertical wall; and
d) water flow and flow-direction elements provided within the rack, to direct the flow of water from one compartment to another compartment located below it.

The invention further relates to a growth tray base for use in a module according to claim 1, comprising a growth assembly consisting of a growth tray, a spacer tray, and a plurality of seedling capsules. In one embodiment of the invention the growth tray has a plurality of growth compartments, each of which can house a separate vegetable growth. In another embodiment of the invention the growth compartments of the growth tray available for separate vegetable growth, are delimited using a spacer tray.

In one embodiment of the invention the growth tray growth compartments are adapted each to receive a seeding capsule containing a vegetable to be grown. In a further embodiment of the invention the seeding capsule contains seeds planted in the soil or growth medium appropriate for growth thereof. In yet another embodiment of the invention the vertical axes of the seeding capsules are tilted with respect to the plane of the rack. In one embodiment of the invention, the tilting of the vertical axes of the seeding capsules is achieved by the slanted shape of the growth tray base.

The invention further provides, in one embodiment, a growth tray adapted to house a sprouting cartridge consisting of a base and a top segmented network. In one embodiment, the sprouting cartridge base is adapted to receive soil or other growth medium, without root separators, or a mesh element for sprouting without soil or other medium.

Also encompassed by the present invention is a module further provided with a water reservoir suitable to provide water to vegetable growing trays. In one embodiment, the module comprises a pumping element and tubing suitable to deliver water to a desired location within the module.

### BRIEF DESCRIPTION OF THE DRAWINGS

FIG. 1A is a front perspective view of a module adapted for vegetable growth, according to an embodiment of the present invention;

FIG. 1B is a rear perspective view of the module of FIG. 1A;

FIG. 1C shows various parts of the module of FIG. 1A in an exploded view;

FIG. 2 illustrates how two modules of FIG. 1A are assembled;

FIG. 3A is a detail of the module of FIG. 1A;

FIG. 3B is a detail of the module rack which is the basis of the module of FIG. 1A;

FIG. 3C shows three module racks in assembled form, according to an embodiment of the present invention;

FIGS. 4A and 4B show the bottom water reservoir that can be added to a module according to one embodiment of the invention.

### DETAILED DESCRIPTION OF THE DRAWINGS

In the context of the present invention the term “vegetable” should be understood to refer to any kind of growth in the vegetable kingdom, including edible, nonedible, and decorative growths. Furthermore, in the context of this invention the term “water” should be understood to refer both to clean water and to water containing additives, such as nutrients and any other material suitable to promote growth or to defend against pathogens that may attack the vegetables.

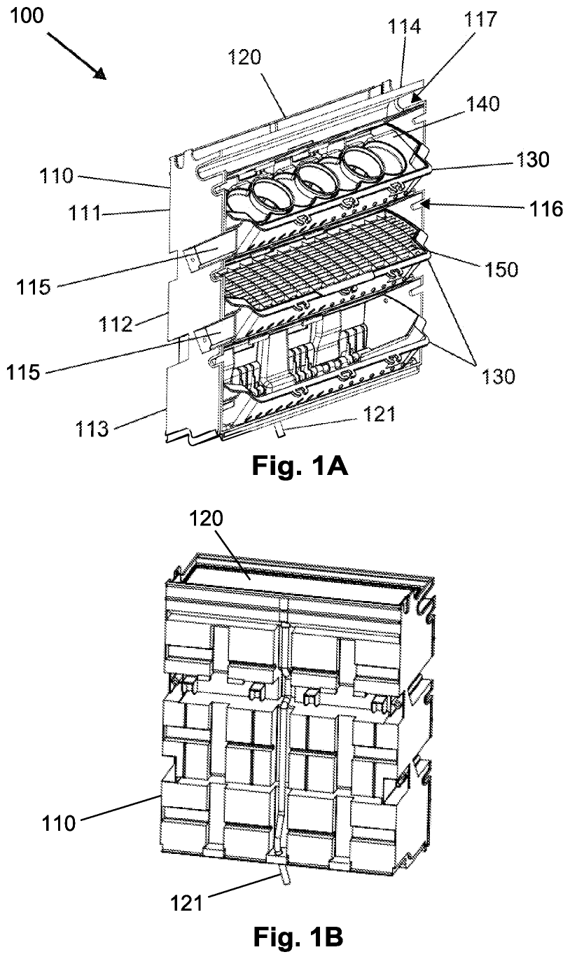

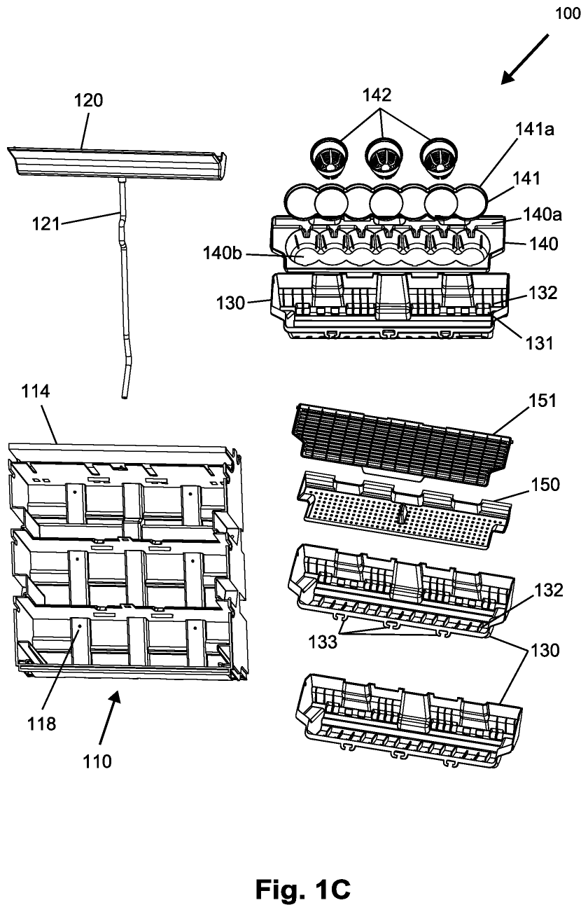

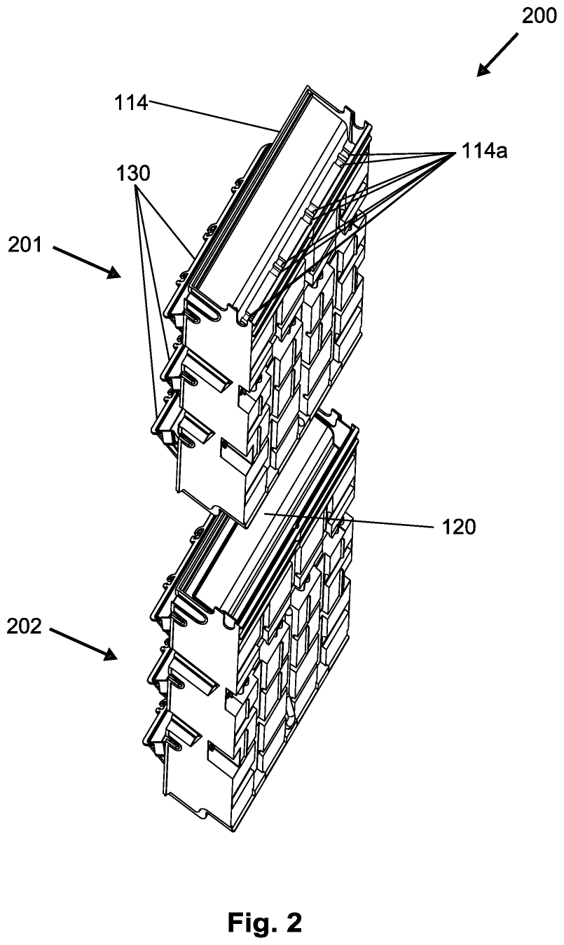

FIG. 1A is a front perspective view of a module 100, according to an embodiment of the present invention, which comprises a rack 110, which in this particular embodiment has three compartments 111-113 located vertically one above each other, but which in other embodiments may be constructed with a larger or smaller number of compartments. Each compartment is adapted to house a growth tray base 130, adapted to house growth trays, which in turn are adapted to receive individual growth compartments. In the particular embodiment of FIG. 1(A-C), the growth compartments are adapted to receive different growth arrangements. In the particular example of FIG. 1(A-C) the top growth compartment receives a growth assembly consisting of growth trays 140, spacer tray 141, and seedling capsules 142. In some embodiments tray 140 is adapted to fit into the growth compartment in the absence of a tray base 130. The middle growth compartment receives a sprouting cartridge consisting of base 150 and top segmented network 151. The bottom growth compartment is seen as empty in the figure.

Returning to the top growth assembly, in this particular embodiment, growth tray 140 has 7 available growth compartments 140b, each of which can in principle house a separate vegetable growth. However, different vegetables have different space requirements for roots and light, and must be spaced from one another accordingly. Using a spacer tray 141, which in this particular embodiment allows for growing three separate vegetables, affords additional flexibility to the exploitation of growth tray 140, since differently structured spacer trays can be used in conjunction with it. Of course, in a different embodiment spacer 141 may be integral with growth tray 140, although obviously the embodiment of FIG. 1 allows for easier access and handling.

Openings 141a in tray 141 are adapted to receive seeding capsules 142, which contain the vegetable to be grown, typically (but not exclusively) as seeds planted in the appropriate soil or growth medium. As can be seen in FIG. 1A, in this particular embodiment of the invention the vertical axes of capsules 142 are tilted with respect to the plane of rack 110. This is advantageous in certain types of growth to promote down-growth of the leafy part of the vegetable and to allow more light to reach the vegetable than it would otherwise reach.

Looking now at the sprouting cartridge in the middle tray, base 150 is adapted to receive soil or other growth medium, without specific separators. This arrangement is suitable for sprouting a variety of vegetables, with the sprouts reaching out of top segmented network 151 after germination.

Of course, many different growth assemblies, other than the two illustrated in FIG. 1, can be devised by the skilled person, and only two examples are given here, for the sake of brevity.

Further shown in FIG. 1A are guiding depressions 115 (corresponding depressions 115 being symmetrically located in both sides of rack 110), which are designed to support the sliding and placement of growth tray base 130 into compartments 111113, therefore being correspondingly shaped with the sides of growth tray base 130, which can also be used to connect other elements of the system, such as, for example, front panels for light control. Rack 110 further comprises a top irrigation intake 114, in which a diversion tub 120 may be installed as will be further explained hereinafter, installation holes 118 (FIG. 1C) which are placeholders for holes to be drilled in order to allow tubing or cables to pass therethrough, or to provide additional draining, and lateral slots 116 and 117 for supporting the assembly of irrigation piping and ancillary equipment.

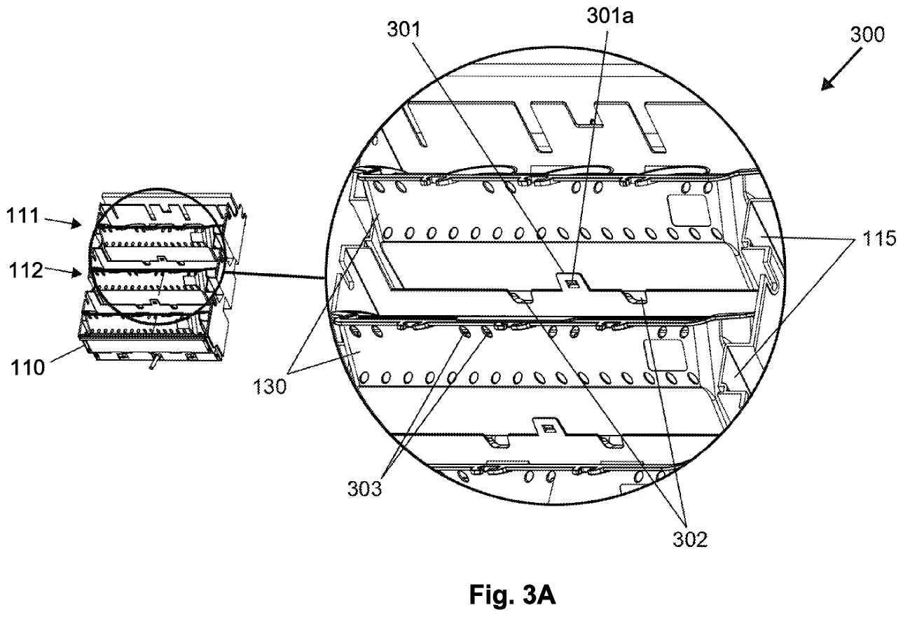

FIG. 1B shows a rear view of platform 100 with diversion tub 120 to which a bypass tube 121 is attached, wherein tub 120 and tube 121 are being used to diverse incoming water from above platform 100 to flow into platform 100 (further illustrated in FIG. 2). If diversion tub 120 is not installed, water and nutrients will cascade down the rack. This may be desirable if the growth all can irrigated using the same nutrients or irrigation water composition, but if different trays are to be irrigated differently, then tub 120 prevents water from cascading down and thus each tray can be irrigated individually. Suitable hanging elements (not shown) are provided in the back of platform 100. These can be of any suitable type, well known to the skilled person and, therefore, they are not shown in detail in the figure, for the sake of simplicity.

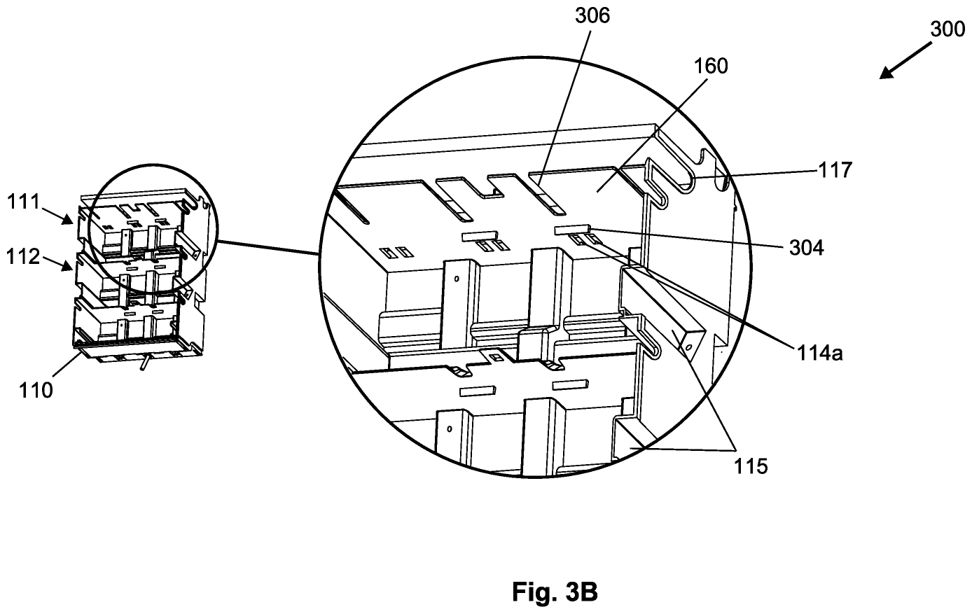

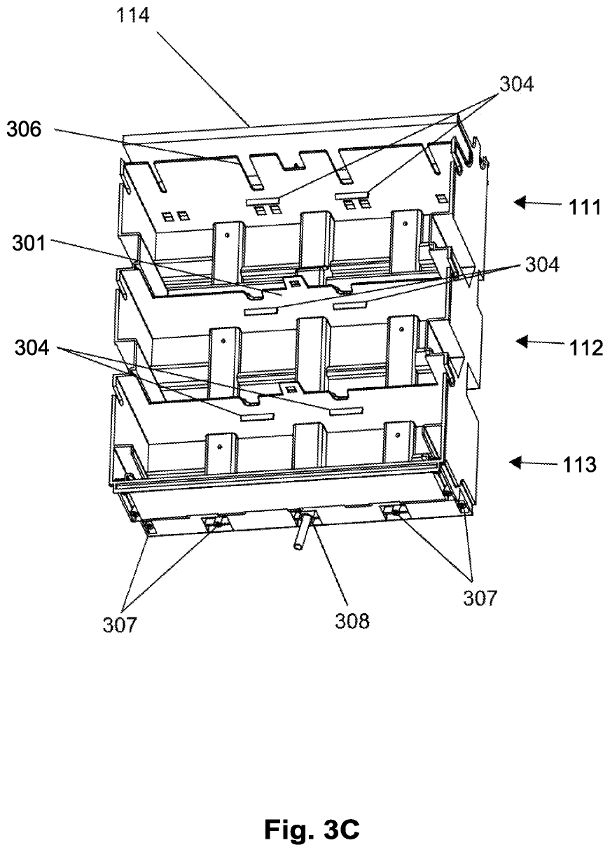

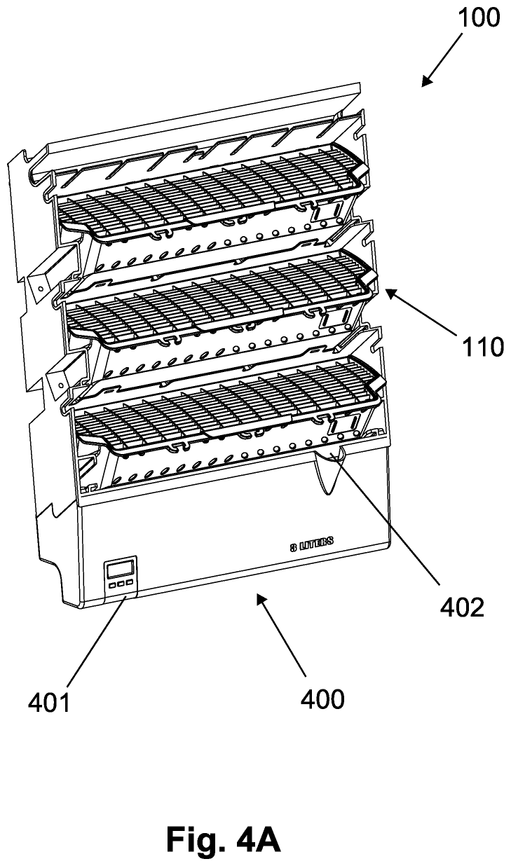

Looking again at FIG. 1C, growth tray 140 has a dripping channel 140a through which drip irrigation liquid flows into the roots growth cavity 140b. Each growth tray base 130 comprises drainage orifices 131 through which surplus irrigation water flows downwards to a lower growth tray base 130, or to a top irrigation intake 114 of module 100 installed underneath module 100 of FIG. 1C (as further illustrated in FIG. 2). Additional openings 305 (FIG. 3C) can be provided in the platform itself, so that when water flowing from drainage orifices 131 reach growth tray base 130, it can further flow toward water directing slab 304 in supporting surface 160, once water has risen to their level. Support ribs 132 are useful to prevent roots from extending laterally, and impart strength to the lightweight structure of growth tray base 130. According to an embodiment of the present invention, growth tray base 130 further comprises auxiliary hangers 133 onto which desirable elements can be attached, such as lighting elements, commercial signs etc.

As will be apparent to the skilled person, the module of the invention can be utilized also for hybrid growing methods, such as combining hydroponic growth with soil or growth medium growing.

A net can be positioned over the module when desired, for decorative purposes, for protecting it while no growth is taking place, or for any other purpose, such as trellising.

FIG. 2 shows a system of two vertically installed modules (separated in the figure for illustration purposes, but which are juxtaposed when in use), according to an embodiment of the present invention, in which the top irrigation intake 114 of module 201 is empty (i.e., does not comprise a diversion tub 120). Therefore, downflowing water (e.g., from another platform installed above module 201) will flow down to the top growth tray base 130 of module 201 and through the growth tray base located below it, down into diversion tub 120 and its corresponding bypass tube 121 (shown in FIG. 1C), and will thus bypass module 202.

For example, one irrigation stream may be used for providing the appropriate irrigation rate to a first type of plants grown in a module above module 201 (not shown), in module 201, and in another module located below platform 202 (not shown), while a second irrigation stream can be used for providing the appropriate irrigation rate to a first type of plants grown in module 202. Accordingly, multiple units of module 100 can be flexibly combined for growing two or more different types of vegetables having different irrigation requirements, while utilizing the minimum required number of irrigation streams, each of which is efficiently routed to the appropriate module. As will be apparent to the skilled person, this results in the saving of water and nutrients, and is environmentally beneficial.

FIG. 3A shows a partial, enlarged view of a module 300, according to an embodiment of the present invention, in which a growth tray base 130 is secured to rack 110 by pin 301, engaged into a latch 301a. This arrangement allows for an easy engagement and removal of growth tray base 130 from rack 110. Further shown in FIG. 3A are drainage slits 302, through which irrigation liquid is drained through drainage orifices 131 (shown in FIG. 1C) of an upper growth tray base 130, down to growth tray base 130 of compartment 112.

FIG. 3B is a partial, enlarged view of elements of rack 110. In addition to elements already described and indicated by the same numerals, water directing slabs 304 are shown, which are useful to cause water flowing through apertures 306 but not 305 (indicated as 114a in the top view of FIG. 2) located behind it. Thus, slabs 304 concentrate a major portion of the dripping water at a position below them, instead of allowing them to flow down uncontrolled.

FIG. 3C is a front, perspective view of rack 110, showing, in addition to the elements described above, also connecting elements 307, adapted to fit into corresponding parts of a rack mounted below the end of a short sleeve 308, through which tube 121 passes, as shown in FIG. 1B. As will be appreciated by the skilled person, connecting elements 307 are only one illustrative example of connecting elements that may be provided according to the invention. Such connecting elements (not shown for the sake of simplicity) may be located at any position in the module, whether on its sides, bottom, top or back. These may include both decorative and functional elements to be connected to the platform, but additional connecting elements can of course be provided.

Looking now at FIGS. 1C and 3C together, the direction of flow of the water can be easily seen. Water is directed by directing slab 304 to growth tray base 130 and the available volume for water holding therein fills, while excess water leaves through openings 131 and is collected at the bottom from where it leaves through slits drainage 302 (FIG. 3A) toward the bottom tray.

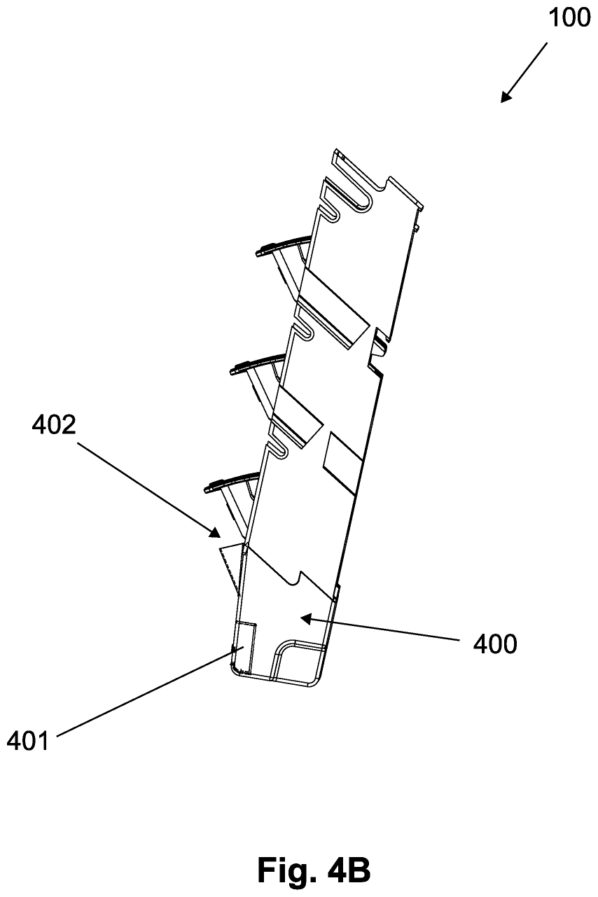

FIG. 4A is a front view of a module 100, according to another embodiment of the invention, which is fitted with a water reservoir 400. Reservoir 400 can receive pure water and/or water containing nutrients, and is provided with pump 401, connected to the tubing (not shown), and is adapted to deliver water to vegetable growth located in the various trays. Tubing leaving pump 401 may be located at any convenient location, e.g. at the front of the growth tray or behind it, such that water is delivered to the uppermost growth tray and/or individually to other trays. An open 402 allows for adding water to the reservoir is desired. FIG. 4B is a side view of the module of FIG. 4A, in which the same elements are seen and indicated by the same numerals.

A variety of plants and parenting arrangements can be used, as will be easily understood by the skilled person, which may include timing arrangements for delivering water at given times and/or with given flowrates and/or in given amounts. Providing such pumping arrangements is well within the scope of the skilled person and therefore it is not described herein in detail for the sake of brevity.

According to an embodiment of the present invention, module 100 may be utilized for displaying plants for sale in supermarkets or any other desirable points of sale, using identical modules or simplified ones, since not all elements employed during growth are needed for displaying. Racks 110 (or, as said, simplified versions thereof) may be located at the point of sale or display, and then an entire growth tray base 130 may be removed from the growing location and transported to the sale location and fitted into the rack located there. Alternatively, display trays may be ready at the sales point, having openings sized like 141a of FIG. 1C, ready to accept capsules 142 with the already grown vegetables. As will be apparent to the skilled person, in view of the modular and flexible nature of the invention, many different alternative display options exist, which can be selected for a specific need.

Although embodiments of the invention have been described by way of illustration, it will be understood that the invention may be carried out with many variations, modifications, and adaptations, without exceeding the scope of the claims.

1. A vegetable growth module comprising:
a) a rack divided into two or more compartments located vertically one above each other, each compartment being adapted to house a growth tray base;
b) an upper segment adapted to house a water-deflecting tub;
c) elements adapted to fasten the rack to a vertical wall; and
d) water flow and flow-direction elements provided within the rack, to direct the flow of water from one compartment to another compartment located below it.

2. A growth tray base for use in a module according to claim 1, comprising a growth assembly consisting of a growth tray, a spacer tray, and a plurality of seedling capsules.

3. A growth tray according to claim 2, having a plurality of growth compartments, each of which can house a separate vegetable growth.

4. A growth tray according to claim 3, wherein the growth compartments available for separate vegetable growth are delimited using a spacer tray.

5. A growth tray according to claim 3, wherein the growth compartments are adapted each to receive a seeding capsule containing a vegetable to be grown.

6. A growth tray according to claim 5, wherein the seeding capsule contains seeds planted in the soil or growth medium appropriate for growth thereof.

7. A growth tray according to claim 5, wherein the vertical axes of the seeding capsules are tilted with respect to the plane of the rack.

8. A growth tray according to claim 7, wherein tilting of the vertical axes of the seeding capsules is achieved by the slanted shape of the growth tray base.

9. A growth tray according to claim 2, adapted to house a sprouting cartridge consisting of a base and a top segmented network.

10. A growth tray according to claim 9, wherein the sprouting cartridge base is adapted to receive soil or other growth medium, without root separators.

11. A module according to claim 1, further provided with a water reservoir suitable to provide water to vegetable growing trays.

12. A module according to claim 11, comprising a pumping element and tubing suitable to deliver water to a desired location within the module.
